(19) United States
(12) Patent Application Publication
(10) Pub. No.: US 2013/0168618 A1
(43) Pub. Date: Jul. 4, 2013

(54) Flame Retardant Thermoplastic Resin Composition

(71) Applicant: Cheil Industries Inc., Gumi-si (KR)

(72) Inventors: Seung Woo Jang, Uiwang-si (KR); Seon Ae Lee, Uiwang-si (KR); Chang Hong Ko, Uiwang-si (KR); Min Soo Lee, Uiwang-si (KR); Sung Hee Ahn, Uiwang-si (KR); Sang Hyun Hong, Uiwang-si (KR)

(73) Assignee: Cheil Industries Inc., Gumi-si (KR)

(21) Appl. No.: 13/709,134

(22) Filed: Dec. 10, 2012

(30) Foreign Application Priority Data
Dec. 30, 2011 (KR) 10-2011-0147917

(51) Int. Cl. C09K 21/14

(52) U.S. Cl. CPC C09K 21/14
USPC 252/601

(57) ABSTRACT

A flame retardant thermoplastic resin composition includes about 100 parts by weight of a base resin including an aromatic vinyl resin and a polyphenylene oxide resin; and about 0.1 to about 30 parts by weight of a polyphosphonate copolymer represented by Formula 1:

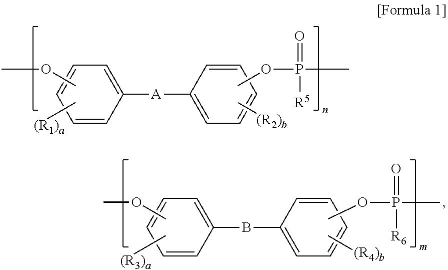

In Formula 1, A and B are each independently a single bond, C₁-C₅ alkylene, C₁-C₅ alkylidene, C₅-C₆ cycloalkylidene, —S— or —SO₂—, provided that A and B are not identical to each other; R₅ and R₆ are each independently substituted or unsubstituted C₁-C₆ alkyl, substituted or unsubstituted C₆-C₂₀ aryl, or substituted or unsubstituted C₆-C₂₀ aryloxy; R₁, R₂, R₃ and R₄ are each independently substituted or unsubstituted C₁-C₆ alkyl, substituted or unsubstituted C₃-C₆ cycloalkyl, substituted or unsubstituted C₆-C₁₂ aryl, or a halogen atom; a and b are each independently an integer from 0 to 4; and n and m are each independently an integer from about 1 to about 500.

### CROSS-REFERENCE TO RELATED APPLICATIONS

This application claims priority under 35 USC Section 119 to and the benefit of Korean Patent Application No. 10-2011-0147917 filed on Dec. 30, 2011, the entire disclosure of which is incorporated herein by reference.

### FIELD OF THE INVENTION

The present invention relates to a flame retardant thermoplastic resin composition.

### BACKGROUND OF THE INVENTION

With increasing interest in environmental issues, regulation on existing halogen flame retardants has been enforced in many countries. Accordingly, there has been increased interest in non-halogen flame retardants capable of replacing halogen flame retardants, such as phosphorus flame retardants.

For example, monomolecular phosphorus flame retardants such as triphenyl phosphate, resorcinol bisphenol phosphate and the like can be used as flame retardants. However, such monomolecular phosphorus flame retardants have a low molecular weight and thus volatilize at high molding temperatures, causing deterioration in appearance of plastic products containing the same. Further, monomolecular phosphorus flame retardants may escape into the outside environment, which can cause environmental contamination.

Accordingly, there is increased interest in polyphosphonates as polymerizable phosphorus flame retardants. Polyphosphonates in polymer form can exhibit excellent properties in terms of flame retardancy, mechanical properties, heat resistance and transparency, as compared with monomolecular phosphorus flame retardants. Polyphosphonates can be used in resins requiring high heat resistance and high transparency, such as polycarbonate resins.

However, existing polyphosphonates are not satisfactory in terms of impact strength, heat resistance and appearance, and tend to partially degrade thermoplastic resins due to structural characteristics thereof, thereby causing deterioration in physical properties. Moreover, existing polyphosphonates can exhibit unsatisfactory compatibility with resins and low dispersibility.

### SUMMARY OF THE INVENTION

The present invention provides a flame retardant thermoplastic resin composition, which is environmentally-friendly, exhibits minimal or no gas formation or degradation issues and can have an excellent balance of physical properties including not only flame retardancy but also transparency, heat resistance, impact strength, appearance and the like. The composition of the invention includes as a flame retardant a polyphosphonate copolymer having two or more repeat units in a backbone thereof.

The flame retardant thermoplastic resin composition includes about 100 parts by weight of a base resin including an aromatic vinyl resin and a polyphenylene oxide resin; and about 0.1 to about 30 parts by weight of a polyphosphonate copolymer represented by Formula 1:

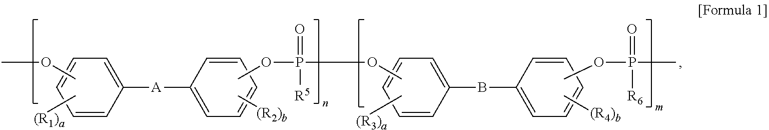

wherein:

A and B are each independently a single bond, C₁-C₅ alkylene, C₁-C₅ alkylidene, C₅-C₆ cycloalkylidene, —S— or —SO₂—, provided that A and B are not identical to each other;

R₅ and R₆ are the same or different and are each independently substituted or unsubstituted C₁-C₆ alkyl, substituted or unsubstituted C₆-C₂₀ aryl, or substituted or unsubstituted C₆-C₂₀ aryloxy;

R₁, R₂, R₃ and R₄ are the same or different and are each independently substituted or unsubstituted C₁-C₆ alkyl, substituted or unsubstituted C₃-C₆ cycloalkyl, substituted or unsubstituted C₆-C₁₂ aryl, or halogen;

a and b are the same or different and are each independently an integer from 0 to 4; and

n and m are the same or different and are each independently an integer from about 1 to about 500.

The base resin may include about 50 wt % to about 99 wt % of an aromatic vinyl resin and about 1 wt % to about 50 wt % of a polyphenylene oxide resin.

The aromatic vinyl resin may include about 1 wt % to about 30 wt % of a rubber polymer and about 70 wt % to 99 wt % of an aromatic vinyl monomer.

The sum of n and m may range from about 3 to about 600.

The polyphosphonate copolymer may have a weight average molecular weight of about 1,000 g/mol to about 50,000 g/mol.

The polyphosphonate copolymer may have a glass transition temperature of about 75° C. to about 90° C.

The polyphosphonate copolymer may have a rate of change in acid value of about 0.005 to about 6, as calculated by Equation 1:

$$Δ A V = \frac{A Va - A Vb}{A Vb} \times 100 , \qquad [ Equation 1 ]$$

wherein ΔAV represents the rate of change in acid value, AVa represents the acid value measured after 10 g of the copolymer is left at 280° C. for 1 hour, and AVb represents the initial acid value of the copolymer.

The polyphosphonate copolymer may include biphenyl units in an amount of about 0.5 mol % to about 99.5 mol %, based on the total mol % of the copolymer.

The thermoplastic resin composition may further include one or more of auxiliary flame retardants, glidants, plasticizers, heat stabilizers, anti-dripping agents, antioxidants, compatibilizers, light stabilizers, pigments, dyes, mineral additives, and the like, and combinations thereof.

The present invention also provides a molded article. The molded article may be molded from the flame retardant thermoplastic resin composition.

### BRIEF DESCRIPTION OF DRAWING

FIG. 1 is NMR data of a polyphosphonate copolymer used in examples of the present invention.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

A flame retardant thermoplastic resin composition according to the present invention includes a base resin including an aromatic vinyl resin and a polyphenylene oxide resin, and a polyphosphate copolymer. Hereinafter, each component of the flame retardant thermoplastic resin composition will be described in detail.

(A) Aromatic Vinyl Resin

The aromatic vinyl resin may be a polymer of an aromatic vinyl monomer, a copolymer of an aromatic vinyl monomer and another copolymerizable monomer, a rubber modified aromatic vinyl resin that is a polymer of an aromatic vinyl monomer and a rubber polymer, or a combination thereof.

Examples of the aromatic vinyl monomer include without limitation styrene, α-methylstyrene, β-methylstyrene, p-methylstyrene, para-t-butylstyrene, ethylstyrene, and the like. These monomers may be used alone or in combination thereof.

Examples of the other copolymerizable monomer include without limitation acrylonitrile, acrylic acid, methacrylic acid, maleic anhydride, N-substituted maleimide, and the like. These monomers may be used alone or in combination thereof.

Examples of the rubber polymer include without limitation diene rubbers, such as butadiene rubbers, copolymers of butadiene and styrene, poly(acrylonitrile-butadiene), and the like, saturated rubbers obtained by hydrogenating the diene rubbers, isoprene rubbers, acrylic rubbers, ethylene-propylene-diene monomer terpolymers (EPDM), and the like, and combinations thereof. In exemplary embodiments, polybutadienes, copolymers of butadiene and styrene, isoprene rubbers, and alkyl acrylate rubbers can be used.

When using the rubber modified aromatic vinyl resin as an aromatic vinyl resin (A), the amount of the rubber polymer can range from about 1 wt % to about 30 wt %, for example from about 5 wt % to about 15 wt %, based on the total weight of the aromatic vinyl resin (A) (rubber modified aromatic vinyl resin). In some embodiments, the rubber modified aromatic vinyl resin can include the rubber polymer in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, or 30 wt %. Further, according to some embodiments of the present invention, the amount of the rubber polymer can be in a range from about any of the foregoing amounts to about any other of the foregoing amounts.

Also when using the rubber modified aromatic vinyl resin as an aromatic vinyl resin (A), the amount of the aromatic vinyl monomer can range from about 70 wt % to about 99 wt %, for example from about 85 wt % to about 95 wt %, based on the total weight of the aromatic vinyl resin (A). In some embodiments, the rubber modified aromatic vinyl resin can include the aromatic vinyl monomer in an amount of about 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 wt %. Further, according to some embodiments of the present invention, the amount of the aromatic vinyl monomer can be in a range from about any of the foregoing amounts to about any other of the foregoing amounts.

When the rubber modified aromatic vinyl resin includes the rubber polymer and aromatic vinyl monomer in amounts within the above ranges, the resin composition can exhibit an excellent balance of physical properties of good impact strength and mechanical properties.

For a blend of the rubber modified aromatic vinyl resin and the polyphenylene oxide resin to exhibit appropriate physical properties, rubber particles can have a Z-average particle size of about 0.1 μm to about 6.0 μm, for example a Z-average particle size of about 0.25 to about 3.5 μm.

Examples of the aromatic vinyl resin (A) include without limitation polystyrene (PS), high impact polystyrene (HIPS), acrylonitrile-butadiene-styrene copolymer resin (ABS), acrylonitrile-styrene copolymer resin (SAN), acrylonitrile-styrene-acrylate copolymer resin (ASA), and the like. They can be used alone or in combination thereof. In exemplary embodiments, polystyrene (PS) or high impact polystyrene (HIPS) can be used due to their good compatibility with polyphenylene ether resins.

Methods of preparing the aromatic vinyl resin (A) are well known to a person skilled in the art and the aromatic vinyl resin can also be commercially obtained.

For example, the aromatic vinyl resin (A) may be polymerized by heat polymerization in the presence of or in the absence of a polymerization initiator. Examples of the polymerization initiator may include without limitation peroxide initiators, such as benzoyl peroxide, t-butyl hydroperoxide, acetyl peroxide, cumene hydroperoxide and the like; and azo initiators such as azobis isobutyronitrile, and the like, and combinations thereof.

The aromatic vinyl resin (A) may be prepared by mass polymerization, suspension polymerization, emulsion polymerization, or a mixed method thereof. Among these polymerization methods, mass polymerization can be used in exemplary embodiments.

The aromatic vinyl resin (A) is a part of the base resin of the resin composition of the present invention. The base resin can include the aromatic vinyl resin (A) in an amount from about 50 wt % to about 99 wt %, for example from about 55 wt % to about 80 wt %, and as another example from about 55 wt % to about 75 wt %, based on the total weight of the base resin composed of (A)+(B). In some embodiments, the base resin may include the aromatic vinyl resin (A) in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 wt %. Further, according to some embodiments of the present invention, the amount of aromatic vinyl resin (A) can be in a range from about any of the foregoing amounts to about any other of the foregoing amounts.

(B) Polyphenylene Ether Resin

Examples of the polyphenylene ether resin (B) include without limitation poly(2,6-dimethyl-1,4-phenylene)ether, poly(2,6-diethyl-1,4-phenylene)ether, poly(2,6-dipropyl-1,4-phenylene)ether, poly(2-methyl-6-ethyl-1,4-phenylene)ether, poly(2-methyl-6-propyl-1,4-phenylene)ether, poly(2-ethyl-6-propyl-1,4-phenylene)ether, poly(2,6-diphenyl-1,4-phenylene)ether, copolymers of poly(2,6-dimethyl-1,4-phenylene)ether and poly(2,3,6-trimethyl-1,4-phenylene)ether, copolymers of poly(2,6-dimethyl-1,4-phenylene)ether and poly(2,3,6-triethyl-1,4-phenylene)ether, and the like, and combinations thereof. In exemplary embodiments, poly(2,6-dimethyl-1,4-phenylene)ether, or a copolymer of poly(2,6-dimethyl-1,4-phenylene)ether and poly(2,3,6-trimethyl-1,4-phenylene)ether can be used, for example, poly(2,6-dimethyl-1,4-phenylene)ether can be used.

The degree of polymerization of the polyphenylene ether resin (B) used in the preparation of the resin composition of the present invention is not particularly limited. A polyphenylene ether resin having an intrinsic viscosity ranging from about 0.2 dl/g to about 0.8 dl/g, as measured in chloroform at 25° C., can be used when taking into consideration heat stability or workability of the resin composition.

The polyphenylene ether resin (B) is also a part of the base resin of the resin composition of the present invention. The base resin can include the polyphenylene ether resin (B) in an amount from about 1 to about 50 wt %, for example from about 20 to about 45 wt %, and as another example about 25 to about 45 wt %, based on the total weight of the base resin composed of (A)+(B). In some embodiments, the base resin may include the polyphenylene ether resin (B) in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 30, 31, 32, 33, 34, 35, 36, 37, 38, 39, 40, 41, 42, 43, 44, 45, 46, 47, 48, 49, or 50 wt %. Further, according to some embodiments of the present invention, the amount of polyphenylene ether resin (B) can be in a range from about any of the foregoing amounts to about any other of the foregoing amounts.

When the base resin includes the polyphenylene ether resin (B) in an amount within this range, the properties of the polyphenylene ether resin can be properly developed, which in turn can give the resin composition good fluidity and impact resistance.

(C) Polyphosphonate Copolymer

The polyphosphonate copolymer used in the present invention is represented by Formula 1.

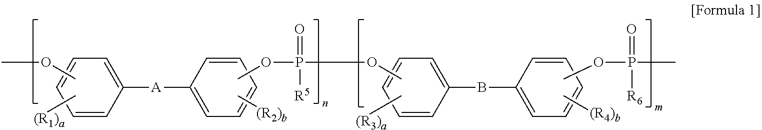

In Formula 1, A and B are each independently a single bond, C₁-C₅ alkylene, C₁-C₅ alkylidene, C₅-C₆ cycloalkylidene, —S— or —SO₂—, provided that A and B are not identical to each other;

R₅ and R₆ are the same or different and are each independently substituted or unsubstituted C₁-C₆ alkyl, substituted or unsubstituted C₆-C₂₀ aryl, or substituted or unsubstituted C₆-C₂₀ aryloxy;

R₁, R₂, R₃ and R₄ are the same or different and are each independently substituted or unsubstituted C₁-C₆ alkyl, substituted or unsubstituted C₃-C₆ cycloalkyl, substituted or unsubstituted C₆-C₁₂ aryl, or halogen;

a and b are the same or different and are each independently an integer from 0 to 4; and
n and m are the same or different and are each independently an integer from about 1 to about 500.

In one embodiment, the sum of n and m is about 3 to about 600. Within this range, the resin composition can exhibit much better flame retardancy.

As used herein, unless otherwise defined, the term “substituted” means that a hydrogen atom of a compound is substituted by a halogen atom, such as F, Cl, Br, and I, a hydroxyl group, a nitro group, a cyano group, an amino group, an azido group, an amidino group, a hydrazino group, a hydrazono group, a carbonyl group, a carbamyl group, a thiol group, an ester group, a carboxyl group or salt thereof, a sulfonic acid group or salt thereof, a phosphate group or salt thereof, a C₁ to C₂₀ alkyl group, a C₂ to C₂₀ alkenyl group, a C₂ to C₂₀ alkynyl group, a C₁ to C₂₀ alkoxy group, a C₆ to C₃₀ aryl group, a C₆ to C₃₀ aryloxy group, a C₃ to C₃₀ cycloalkyl group, a C₃ to C₃₀ cycloalkenyl group, a C₃ to C₃₀ cycloalkynyl group, or a combination thereof.

The polyphosphonate copolymer (C) may be prepared by reacting a diol represented by Formula 2-1, a diol represented by Formula 2-2 and a phosphonic dichloride represented by Formula 3.

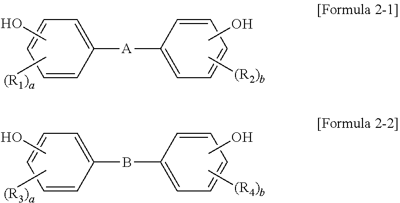

In Formulas 2-1 and 2-2, A, B, R₁, R₂, R₃, R₄, a and b are the same as defined in Formula 1.

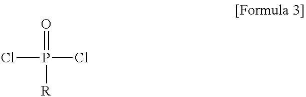

In Formula 3, R is substituted or unsubstituted C₁-C₆ alkyl, substituted or unsubstituted C₆-C₂₀ aryl, or substituted or unsubstituted C₆-C₂₀ aryloxy.

As the phosphonic dichloride represented by Formula 3, two types of compounds wherein R is not identical may be used. R in Formula 3 corresponds to R₅ and R₆ in Formula 1.

Examples of the diols include without limitation 4,4′-dihydroxybiphenyl, 2,2-bis-(4-hydroxyphenyl)-propane, 2,4-bis-(4-hydroxyphenyl)-2-methylbutane, 1,1-bis-(4-hydroxyphenyl)-cyclohexane, 2,2-bis-(3-chloro-4-hydroxyphenyl)-propane, 2,2-bis-(3,5-dichloro-4-hydroxyphenyl)-propane, and the like. These diols may be used in combination thereof. In exemplary embodiments, 4,4′-dihydroxybiphenyl and 2,2-bis-(4-hydroxyphenyl)-propane can be used.

The ratio between two types of diols may be properly adjusted in accordance with desired physical properties. For example, in one embodiment, the molar ratio between 4,4′-dihydroxybiphenyl and 2,2-bis-(4-hydroxyphenyl)-propane may be about 5 to about 95: about 95 to about 5.

In some embodiments, the combination of the diols of Formulas 2-1 and 2-2 may include a diol represented by Formula 2-1 in an amount of about 5, 6, 7, 8, 9, 10, 11, 12, 13, 14, 15, 16, 17, 18, 19, 20, 21, 22, 23, 24, 25, 26, 27, 28, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 mol %. Further, according to some embodiments of the present invention, the amount of a diol represented by Formula 2-1 can be in a range from about any of the foregoing amounts to about any other of the foregoing amounts.

In some embodiments, the combination of the diols of Formulas 2-1 and 2-2 may include a diol represented by Formula 2-2 in an amount of about 5, 6, 7, 8, 9, 10, 11, 12, 13, 14, 15, 16, 17, 18, 19, 20, 21, 22, 23, 24, 25, 26, 27, 28, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 mol %. Further, according to some embodiments of the present invention, the amount of a diol represented by Formula 2-2 can be in a range from about any of the foregoing amounts to about any other of the foregoing amounts.

When the ratio of the diols of represented by Formula 2-1 and Formula 2-2 is within this range, the resin composition of the present invention can exhibit much better flame retardancy.

In one embodiment, the polyphosphonate copolymer may be prepared by adding the phosphonic dichloride to a solution obtained by mixing two types of diols, a catalyst and a terminal capping agent.

In one embodiment, the phosphonic dichloride and the total of the diols may be reacted in an equivalent ratio of about 1:1.

The reaction between the diols and phosphonic dichloride may be carried out by a conventional polymerization in the presence of a Lewis acid catalyst. The polymerization can be carried out by solution polymerization.

Examples of the Lewis acid catalyst include without limitation aluminum chloride, magnesium chloride, and the like, and combinations thereof. The catalyst may be added in an equivalent of about 0.01 to about 10, for example about 0.01 to about 1, and as another example about 0.01 to about 0.1, based on about 1 equivalent of the sum of the diols.

Further, the reaction may be carried out in the presence of a terminal capping agent. Examples of the terminal capping agent include without limitation C₁-C₅ alkyl group containing phenol. For example, phenol, 4-t-butylphenol, or 2-t-butylphenol may be used. The terminal capping agent may be added in an equivalent of about 1 or less, for example about 0.01 to about 0.5, based on about 1 equivalent of the sum of the diols.

In one embodiment, after completing the reaction, the resultant product may be washed with an acid solution. Examples of the acid solution include without limitation phosphoric acid, hydrochloric acid, nitric acid, sulfuric acid, and the like, and combinations thereof. In exemplary embodiments, phosphoric acid or hydrochloric acid can be used. The acid solution may be used in a concentration of about 0.1% to about 10%, for example about 1% to about 5%.

Then, the polyphosphonate copolymer in a white solid form may be obtained via washing and filtration. The polyphosphonate copolymer prepared as above is linear and does not contain a bisphenol structure.

The polyphosphonate copolymer (C) may have a weight average molecular weight of about 1,000 g/mol to about 50,000 g/mol, for example about 1,000 g/mol to about 20,000 g/mol, and as another example about 1,000 g/mol to about 10,000 g/mol, as measured by GPC (Gel Permeation Chromatography). When the polyphosphonate copolymer (C) has a weight average molecular weight within this range, the resin composition can exhibit much better flame retardancy.

The polyphosphonate copolymer may have an acid value from about 0.005 KOH mg/g to about 6 KOH mg/g, for example from about 0.01 KOH mg/g to about 3 KOH mg/g. When the polyphosphonate copolymer (C) has an acid value within this range, the resin composition can prevent degradation of the thermoplastic resin.

The polyphosphonate copolymer may have a polydispersity index (PDI) from about 1.5 to about 3.5, for example from about 1.8 to about 3.5. When the polyphosphonate copolymer (C) has a PDI within this range, the resin composition can exhibit a good balance of physical properties of flame retardancy, fluidity, impact strength, heat resistance, and the like.

The polyphosphonate copolymer may have a glass transition temperature from about 75° C. to about 90° C., for example from about 78° C. to about 87° C. When the polyphosphonate copolymer (C) has a glass transition temperature within this range, the resin composition can exhibit good processability.

The polyphosphonate copolymer (C) may have a rate of change in acid value of about 0.005 to about 6, for example about 0.01 to about 5, as calculated by Equation 1.

$$Δ A V = \frac{A Va - A Vb}{A Vb} \times 100 \qquad [ Equation 1 ]$$

In Equation 1, ΔAV represents the rate of change in acid value, AVa represents the acid value measured after 10 g of the copolymer is left at 280° C. for 1 hour, and AVb represents the initial acid value of the copolymer.

The polyphosphonate copolymer (C) may have biphenyl units in an amount of about 0.5 mol % to about 99.5 mol %, for example about 1 mol % to about 50 mol %, based on the total mol % of the copolymer. In some embodiments, the polyphosphonate copolymer (C) may include biphenyl units in an amount of about 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.1, 99.2, 99.3, 99.4, or 99.5 mol %. Further, according to some embodiments of the present invention, the amount of biphenyl units can be in a range from about any of the foregoing amounts to about any other of the foregoing amounts.

When the polyphosphonate copolymer (C) includes biphenyl units in an amount within this range, the resin composition can exhibit much better flame retardancy.

The composition of the invention can include the polyphosphonate copolymer (C) in an amount of about 0.1 to about 30 parts by weight, for example about 1 to about 25 parts by weight, based on about 100 parts by weight of the base resin composed of (A) and (B). In some embodiments, the composition of the invention can include the polyphosphonate copolymer (C) in an amount of about 0.1, 0.2, 0.3, 0.4, 0.5, 0.6, 0.7, 0.8, 0.9, 0 1, 2, 3, 4, 5, 6, 7, 8, 9, 10, 11, 12, 13, 14, 15, 16, 17, 18, 19, 20, 21, 22, 23, 24, 25, 26, 27, 28, or 30 parts by weight. Further, according to some embodiments of the present invention, the amount of polyphosphonate copolymer (C) can be in a range from about any of the foregoing amounts to about any other of the foregoing amounts.

When the composition includes the polyphosphonate copolymer (C) in an amount within this range, the resin composition can exhibit a good balance of physical properties of flame retardancy, fluidity, impact strength, heat resistance, and the like.

As needed, the thermoplastic resin composition may additionally include one or more additives. Examples of the additives include without limitation auxiliary flame retardants, glidants, plasticizers, heat stabilizers, anti-dripping agents, antioxidants, compatibilizers, light stabilizers, pigments, dyes, mineral additives, and the like. These additives may be used alone or in combination thereof.

The thermoplastic resin composition of the present invention may be formed into pellets by mixing the constituent components and other additives simultaneously and then melt extruding the resultant mixture in an extruder. The pellets may be molded by various molding processes such as injection molding, extrusion molding, vacuum molding, casting molding, and the like to produce molded articles.

The invention also provides molded articles made from the thermoplastic resin composition. The molded articles can have excellent properties in terms of impact resistance, fluidity, flame retardancy and the like, and thus the molded articles may be broadly used as components for electric-electronic products, exterior materials, automotive parts, miscellaneous goods, construction materials, and the like.

Next, the constitution and functions of the present invention will be explained in more detail with reference to the following examples. It should be understood that these examples are provided for illustrative purposes only and are not to be in any way construed as limiting the present invention. A description of details apparent to those skilled in the art will be omitted herein.

### EXAMPLES

Specifications of the components used in the examples and comparative examples are as follows:

(A) Aromatic vinyl resin: HIPS resin (HG-1730, manufactured by CHEIL Industries) is used.

(B) Polyphenylene ether (PPE) resin: Poly(2,6-dimethyl-phenylether (S-202, manufactured by Asahi Kasei Company, Japan) is used.

(C) Flame retardant

(C-1) Polyphosphonate copolymer

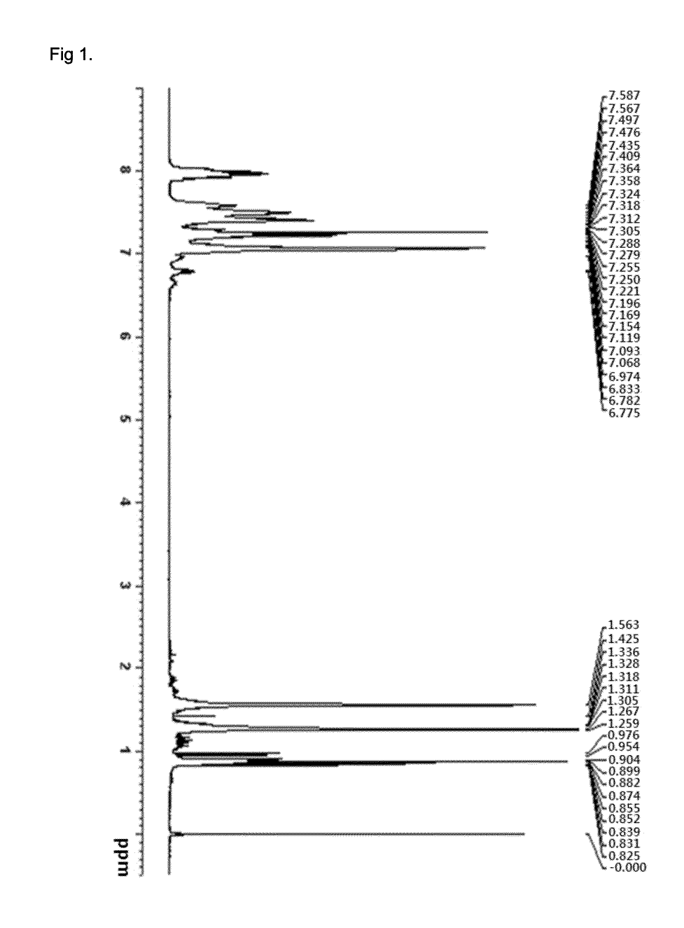

7.18 kg (38.54 mol) of biphenol (Songwon Industrial Co., Ltd.), 8.80 kg (38.54 mol) of 2,2-bis-(4-hydroxyphenyl)-propane (Kumho Industries Co., Ltd.), 5.79 kg (38.54 mol) of 4-t-butylphenol (TCI Co., Ltd.) as a terminal capping agent, and 0.51 kg (3.82 mol) of aluminum chloride are added to 100 kg of chlorobenzene (Samchun Chemical Co. Ltd.) and then dissolved at 145° C. To the resultant solution, 15.45 kg (77.08 mol) of phenyl phosphonic dichloride (IDB Co., Ltd.) is slowly added dropwise and then stirred for 8 hours. The mixture is washed with an aqueous hydrochloric acid solution and distilled water and the washing procedure is repeated twice to obtain an organic layer. After dehydrogenation of the organic layer, the resultant product is precipitated in hexane (Samchun Chemical Co. Ltd.) to obtain a polyphosphonate copolymer in a white solid form. The NMR (Briker AVANCE III & Ultrashield Magnet Company, 300 MHz) data for the prepared copolymer are shown in FIG. 1. The number average molecular weight and the weight average molecular weight of the prepared polyphosphonate copolymer are 2,100 g/mol and 4,400 g/mol, respectively. In addition, the prepared polyphosphonate copolymer has a PDI (polydispersity index) of 2.1, a glass transition temperature of 82° C., and an acid value of 0.01 KOH mg/g. The rate of change in acid value calculated from Equation 1 is 0.64.

(C-2) Bisphenol group containing polyphosphonate

1 equivalent of bisphenol A (Songwon Industrial Co., Ltd.), 0.2 equivalent of 4-t-butylphenol as a terminal capping agent and 0.01 equivalent of aluminum chloride are added to chlorobenzene where chlorobenzene is used at 6 times greater than the amount of bisphenol. After warming to 131° C., 1 equivalent of phenylphosphonic dichloride (Acros Co., Ltd.) is added dropwise, thereby initiating the reaction. After completion of dropping, the resultant mixture is stirred for 2 hours and the reaction completed. After completion of the reaction, the temperature is decreased to 80° C., and the resultant product is washed with a 10% aqueous hydrochloric acid solution and then with water twice. After washing, the aqueous layer is removed and the organic layer is removed by reduced pressure distillation to produce a bisphenol group containing polyphosphonate (C-2). The prepared polymer (C-2) has a weight average molecular weight of 3,400 g/mol, PDI of 1.9 and an acid value of 0.01 KOH mg/g. The rate of change in acid value calculated from Equation 1 is 0.69.

(C-3) Phosphoric ester flame retardant: CR-741S (Daihachi, Japan) is used.

(C-4) Phosphoric ester flame retardant: PX-200 (Daihachi, Japan) is used.

### Examples 1-2 and Comparative Examples 1-6

Each component defined as above is added in an amount shown in Table 1 to a conventional twin-screw extruder and then extruded at a temperature range from 200° C. to 280° C. to obtain pellets. The pellets are dried at 70° C. for 2 hours and molded by a 10 oz injection molding machine at a molding temperature of 180° C. to 280° C. and a mold temperature of 40° C. to 80° C. to produce specimens. The physical properties of the prepared specimens are evaluated in accordance with the following methods. The results are provided in Table 1.

Evaluation of Physical Properties

(1) Flame retardancy: Flame retardancy is measured on a ⅛″ thick specimen in accordance with UL94 VB flame retardant standards.

(2) Heat resistance (VST): Heat resistance is measured under conditions of 5 kg, 50° C./HR in accordance with ISO R 306.

(3) Heat deformation temperature: Heat deformation temperature is measured by applying a surface pressure of 1.82 MPa in accordance with ASTM D648 (° C.).

(4) Izod impact strength: Izod impact strength is measured on a ⅛″ thick notched specimen at room temperature in accordance with ASTM D-256 (kgf·cm/cm).

(5) Melt flow index: The melt flow index is measured under conditions of 250° C., 10 kg (g/10 min).

TABLE 1

| | | Examples | | Comparative Examples | | | | | |
|---|---|---|---|---|---|---|---|---|---|
| | | 1 | 2 | 1 | 2 | 3 | 4 | 5 | 6 |
| HIPS | | 55 | 55 | 55 | 55 | 55 | 55 | 55 | 55 |
| PPE | | 45 | 45 | 45 | 45 | 45 | 45 | 45 | 45 |
| Flame | (C-1) | 15 | 20 | — | — | — | — | — | — |
| Retardant | (C-2) | — | — | 15 | 20 | — | — | — | — |
| | (C-3) | — | — | — | — | 15 | 20 | — | — |
| | (C-4) | — | — | — | — | — | — | 15 | 20 |

| | | | | | | | | |
|---|---|---|---|---|---|---|---|---|
| Flame retardancy | V-1 | V-1 | V-1 | V-1 | V-1 | Fail | V-1 | V-1 |
| Vicat softening | 129.0 | 126.1 | 124.9 | 125.2 | 103.1 | 103.5 | 106 | 97.5 |
| point (° C.) | | | | | | | | |
| Heat deformation | 111.9 | 111.3 | 112.9 | 111.0 | 89.5 | 89 | 91 | 83.2 |
| temperature (° C.) | | | | | | | | |
| IZOD impact | 7.9 | 6.6 | 6.2 | 3.9 | 8.1 | 6.9 | 8.3 | 6.8 |
| strength | | | | | | | | |
| Melt flow index | 43 | 102 | 58 | 109 | 85 | 72 | 45 | 70 |

As shown in Table 1, Comparative Examples 3-6 using monomolecular flame retardants exhibit deteriorated heat resistance, as compared to Comparative Examples 1 and 2 using polyphosphonates. Further, Examples 1 and 2 using the polyphosphonate copolymers of the present invention exhibit excellent impact strength and heat resistance, as compared to Comparative Examples 1 and 2.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A flame retardant thermoplastic resin composition comprising: about 100 parts by weight of a base resin comprising an aromatic vinyl resin and a polyphenylene oxide resin; and about 0.1 to about 30 parts by weight of a polyphosphonate copolymer represented by Formula 1: 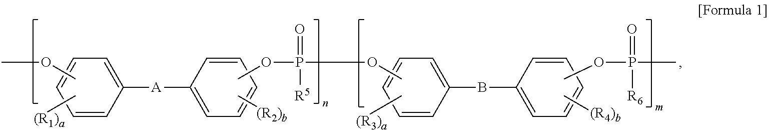
wherein:
A and B are each independently a single bond, C₁-C₅ alkylene, C₁-C₅ alkylidene, C₅-C₆ cycloalkylidene, —S— or —SO₂—, provided that A and B are not identical to each other;
R₅ and R₆ are the same or different and are each independently substituted or unsubstituted C₁-C₆ alkyl, substituted or unsubstituted C₆-C₂₀ aryl, or substituted or unsubstituted C₆-C₂₀ aryloxy;
R₁, R₂, R₃ and R₄ are the same or different and are each independently substituted or unsubstituted C₁-C₆ alkyl, substituted or unsubstituted C₃-C₆ cycloalkyl, substituted or unsubstituted C₆-C₁₂ aryl, or halogen;
a and b are the same or different and are each independently an integer from 0 to 4; and
n and m are the same or different and are each independently an integer from about 1 to about 500.)

2. The flame retardant thermoplastic composition according to claim 1, wherein the base resin comprises about 50 wt % to about 99 wt % of an aromatic vinyl resin and about 1 wt % to about 50 wt % of a polyphenylene oxide resin.

3. The flame retardant thermoplastic composition according to claim 1, wherein the aromatic vinyl resin comprises about 1 wt % to about 30 wt % of a rubber polymer and about 70 wt % to 99 wt % of an aromatic vinyl monomer.

4. The flame retardant thermoplastic composition according to claim 1, wherein the sum of n and m ranges from about 3 to about 600.

5. The flame retardant thermoplastic composition according to claim 1, wherein the polyphosphonate copolymer has a weight average molecular weight of about 1,000 g/mol to about 50,000 g/mol.

6. The flame retardant thermoplastic composition according to claim 1, wherein the polyphosphonate copolymer has a glass transition temperature of about 75° C. to about 90° C.

7. The flame retardant thermoplastic composition according to claim 1, wherein the polyphosphonate copolymer has a rate of change in acid value of about 0.005 to about 6, as calculated by Equation 1:
$$Δ A V = \frac{A Va - A Vb}{A Vb} \times 100 , \qquad [ Equation 1 ]$$
wherein ΔAV represents the rate of change in acid value, AVa represents the acid value measured after 10 g of the copolymer is left at 280° C. for 1 hour, and AVb represents the initial acid value of the copolymer.

8. The flame retardant thermoplastic composition according to claim 1, wherein the polyphosphonate copolymer comprises biphenyl units in an amount of about 0.5 mol % to about 99.5 mol %, based on the total weight of the copolymer.

9. The flame retardant thermoplastic composition according to claim 1, wherein the thermoplastic resin composition further comprises an auxiliary flame retardant, glidant, plasticizer, heat stabilizer, anti-dripping agent, antioxidant, compatibilizer, light stabilizer, pigment, dye, mineral additive or a combination thereof.

10. A molded article molded from the flame retardant thermoplastic composition according to claim 1.
